(19) United States
(12) Patent Application Publication
(10) Pub. No.: US 2022/0308387 A1
(43) Pub. Date: Sep. 29, 2022

(54) BLACK MATRIX FOR LCD PANEL AND LCD PANEL

(71) Applicant: Yongchao Zhao, (US)

(72) Inventor: Yongchao Zhao, (US)

(21) Appl. No.: 17/251,800

(22) PCT Filed: Nov. 4, 2020
(86) PCT No.: PCT/CN2020/126479

§ 371 Date: Dec. 13, 2020

(51) Int. Cl. G02F 1/1335; G02F 1/1337

(52) U.S. Cl. CPC G02F 1/133512; G02F 1/1337

(57) ABSTRACT

The present disclosure provides a black matrix for LCD panel and the LCD panel. The black matrix is a pattern layer of MoTi, and a thickness of the pattern layer of MoTi ranges from 1000 Å to 2000 Å. MoTi is used as the black matrix material instead of resin-type black matrix. MoTi has desirable light-shading performance, and the thickness of only 0.1 μm thereof can achieve the same effect as the existing resin-type black matrix with a thickness of 1 μm, which effectively reduces the thickness of the black matrix, flattens the substrate topography, and benefits to the flow of the alignment liquid to effectively improve the non-stick defect of the alignment liquid, so that the thickness of the alignment film is uniform and the quality of the liquid crystal display panel is improved.

### FIELD OF INVENTION

This present disclosure generally relates to the field of display technology, and in particular to a black matrix for a liquid crystal display (LCD) panel and the LCD panel.

### BACKGROUND OF INVENTION

A thin film transistor (TFT) liquid crystal display panel mainly includes a TFT substrate, a color filter (CF) substrate, and a liquid crystal layer sandwiched between the TFT substrate and the CF substrate. A conductive film and an alignment film are disposed on a surface of the TFT substrate and a surface of the CF substrate. The main function of the alignment film is to align liquid crystal molecules. However, nowadays, as requirements for the display effect of the display panel is becoming higher and higher, and the panel design is getting more and more complicated. Especially in panels with high pixels per inch (PPI), the substrate topography varies greatly, thereby resulting in uneven flow of alignment liquid during the alignment film manufacturing process, and thus the uniformity of the alignment film may be affected. A color photoresist layer of the liquid crystal display (LCD) panel based on color filter on array (COA) technology is integrated onto one side of the TFT substrate. The other substrate without any color photoresist layer is only provided with a black matrix layer (BM), a conductive layer, an alignment film, and other layers. The height of the traditional black matrix particularly worsens the unevenness problem of the panel alignment film for the COA-type device.

FIG. 1 and FIG. 2 are schematic diagrams showing the structure of a COA-type liquid crystal display panel in the prior art. Since the thickness of the resin-type BM 12 is usually up to 1 μm, and spacing thereof is narrow, it is impossible to ensure that the alignment liquid is distributed into each pixel. The alignment liquid cannot cross the BM, due to the blocking effect of the BM thickness, and thus there is no alignment liquid in some pixels, which will eventually lead to uneven thickness of the alignment film in this area or the non-stick defect of the alignment liquid, thereby causing bright spots on the LCD panel and reducing the quality of the panel.

### SUMMARY OF INVENTION

The present disclosure provides a new black matrix for a LCD panel and the LCD panel. The thickness of the black matrix is reduced to improve the non-stick defect and the quality of the panel.

The present disclosure provides a black matrix for a liquid crystal panel, wherein the black matrix is a pattern layer of MoTi, and a thickness of the pattern layer of MoTi ranges from 1000 Å to 2000 Å.

In some embodiments, an optical density value (OD) of the pattern layer of MoTi is greater than or equal to 4.

The present disclosure provides a substrate for a liquid crystal panel, and the substrate comprises a base substrate and a black matrix disposed on a surface of the base substrate. The black matrix is a pattern layer of MoTi, and the thickness of the pattern layer of MoTi ranges from 1000 Å to 2000 Å.

In some embodiments, an optical density value (OD) of the pattern layer of MoTi is greater than or equal to 4.

In some embodiments, an alignment film is disposed on the surface of the base substrate where the black matrix is disposed.

The present disclosure also provides a liquid crystal panel. The liquid crystal panel comprises a first substrate and a second substrate that are arranged oppositely and in parallel, wherein a black matrix, a metal electrode layer, and a first alignment film are arranged sequentially on a surface of the first substrate facing the second substrate, and the black matrix is a pattern layer of MoTi.

In some embodiments, the thickness of the pattern layer of MoTi ranges from 1000 Å to 2000 Å.

In some embodiments, an optical density value (OD) of the pattern layer of MoTi is greater than or equal to 4.

In some embodiments, the liquid crystal panel is a COA type liquid crystal panel, and a thin film transistor array and a color photoresist layer are disposed on one side of the second substrate. For example, a color photoresist layer, an electrode layer and a second alignment film are arranged sequentially on a surface of the second substrate facing the first substrate, and a liquid crystal layer is disposed between the second alignment film and the first alignment film.

The present disclosure also provides a manufacturing method for a black matrix for a liquid crystal panel, comprising steps of
providing a base substrate;
forming a MoTi coating on a surface of the base substrate; and
etching the MoTi coating to form a black matrix pattern.

### Advantageous Effects

Aiming at the problems of the great thickness and the narrow spacing of the resin-type black matrix in the prior art, which affect the fluidity of the alignment liquid, and cause the non-stick defect of the alignment liquid, MoTi is used as the black matrix material in the present disclosure. MoTi has desirable light-shading performance, and the thickness of only 0.1 μm thereof can achieve the same effect as the existing resin-type black matrix with a thickness of 1 μm, which effectively reduces the thickness of the black matrix, flattens the substrate topography, and benefits to the flow of the alignment liquid to effectively improve the non-stick defect of the alignment liquid, so that the thickness of the alignment film is uniform and the quality of the liquid crystal display panel is improved.

### DESCRIPTION OF DRAWINGS

In order to describe clearly the embodiment in the present disclosure or the prior art, the following will introduce the drawings for the embodiment shortly.

FIG. 1 is a cross-sectional view of a structure of a color filter on array (COA) liquid crystal panel in a prior art, wherein a color photoresist is integrated onto a thin film transistor (TFT) substrate, and an opposite substrate has only a base substrate and a black matrix (BM).

FIG. 2 is a schematic diagram of a coating of alignment liquid in a manufacturing process of the COA liquid crystal panel substrate in the prior art, wherein a thickness of a resin type BM hinders flow of the alignment liquid.

FIG. 3 is an application schematic diagram of alignment liquid in a manufacturing process of a liquid crystal panel substrate in accordance with an embodiment of the present disclosure.

FIG. 4 is a cross-sectional view of a structure of a COA liquid crystal panel in accordance with an embodiment of the present disclosure.

FIG. 5 is a cross-sectional view of a structure of a non-COA liquid crystal panel in accordance with an embodiment of the present invention.

### DETAILED DESCRIPTION OF PREFERRED EMBODIMENTS

The following content combines with the drawings and the embodiment for describing the present invention in detail. It is obvious that the following embodiments are only some embodiments of the present invention. For the person of ordinary skill in the art without creative effort, the other embodiments obtained thereby are still covered by the disclosure.

In the description of the present application, it is to be understood that the orientation or positional relationship indicated by the terms such as “length”, “width”, “thickness”, “top”, “bottom”, etc. is based on the orientation or positional relationship shown in the drawings, and is only for convenience of description of the present application and simplified description, which is not indicating or implying that the device or component referred to must have a particular orientation, constructed and operated in a particular orientation, thus it is not to be construed as limiting the invention. Moreover, the terms “first” and “second” are used for descriptive purposes only and are not to be construed as indicating or implying a relative importance or implicitly indicating the number of technical features indicated. Thus, features defining “first” or “second” may include one or more of the described features either explicitly or implicitly. In the description of the present application, the meaning of “a plurality” is two or more unless specifically and specifically defined otherwise.

The following disclosure provides different implementations or examples to implement this application. In order to simplify the disclosure of this application, specific embodiments are described below. Of course, they are only examples and are not intended to limit the application. In addition, reference numerals and/or reference letters are repeated in different examples. Such repetition is for the purpose of simplification and clarity, and it does not indicate the relationship between the various embodiments and/or settings discussed. Furthermore, the present disclosure provides examples of various specific processes and materials, but people of ordinary skill in the art may be aware of the application of other processes and/or the use of other materials.

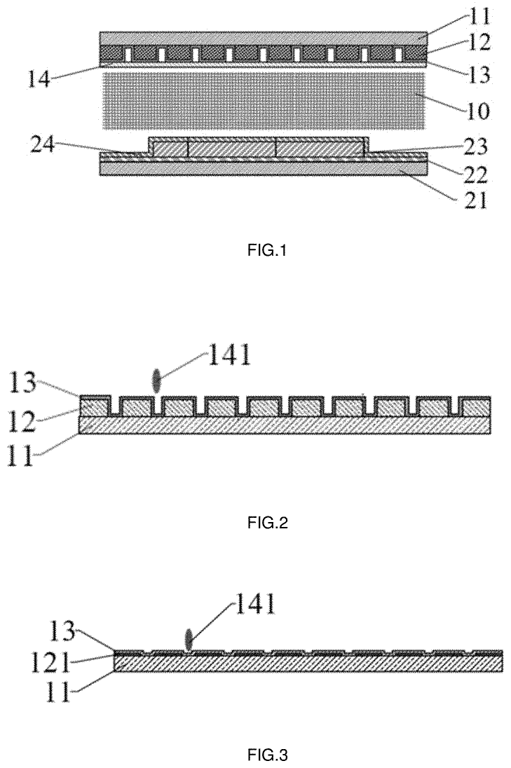

FIG. 1 and FIG. 2 respectively illustrate the cross-sectional view of the structure of a COA-type liquid crystal display panel and the coating process of the alignment liquid on the side of the black matrix substrate in a prior art. As shown in FIG. 1, the COA-type liquid crystal display panel comprises a first base substrate 11, and a black matrix 12 (light-shielding layer), a protective film 13, a first alignment film 14 are sequentially disposed on one surface of the first base substrate 11. A second base substrate 21 is oppositely arranged in parallel with the first base substrate 11. A TFT array 22, color photoresists 23 and a second alignment film 24 are disposed on a surface of the second base substrate 21 facing the first substrate 11. A liquid crystal layer 10 is disposed between the first alignment film 14 and the second alignment film 24. Please refer to FIG. 1 and FIG. 2. since the color photoresists 23 are integrated onto the second base substrate 21 including the TFT array, the first base substrate 11 loses the flattening effect brought by the color photoresists 23. The thickness of the resin-type black matrix 12 is greater than 1 μm, and the spacing is less than 98 μm. Especially in devices with high pixels per inch (PPI), the spacing of the black matrix 12 is narrow. In the process of inkjet printing and coating of the alignment liquid 141, the distance between nozzles of a machine cannot ensure that the alignment liquid 141 is directly sprayed into each pixel. Since the thickness of the resin-type black matrix 12 is greater than 1 μm, the alignment liquid 141 cannot flow into other pixels across the black matrix with the thickness of 1 μm. Therefore, there is no alignment liquid 141 in some pixels, which eventually causes the non-stick defect of the alignment liquid in this area. The thickness of the first alignment film 14 is not uniform, thereby resulting bright spots on the liquid crystal panel.

An embodiment of the present invention provides a black matrix. Please refer to FIG. 3, a black matrix 121 provided by the embodiment of the present invention is disposed on one surface of a base substrate 11, and the black matrix 121 is a pattern layer of MoTi. A thickness of the black matrix 121 ranges from 1000 Å-2000 Å (0.1-0.2 μm).

In some embodiments, the OD value of the black matrix 121 is greater than or equal to 4, which can achieve a desirable shading effect.

The pattern layer of MoTi can be prepared by a metal layer preparation process known in the art. For example, a MoTi metal layer is formed on the surface of the base substrate 11, and then a photosensitive layer, such as a photoresist, is formed on the MoTi metal layer. A photoresist pattern is obtained through a photolithography process, and the photoresist pattern is used as a mask for etching the MoTi metal layer to form a MoTi shading pattern. The MoTi metal layer can be formed on the surface of the base substrate 11 through sputtering, vapor deposition, spraying, and other processes.

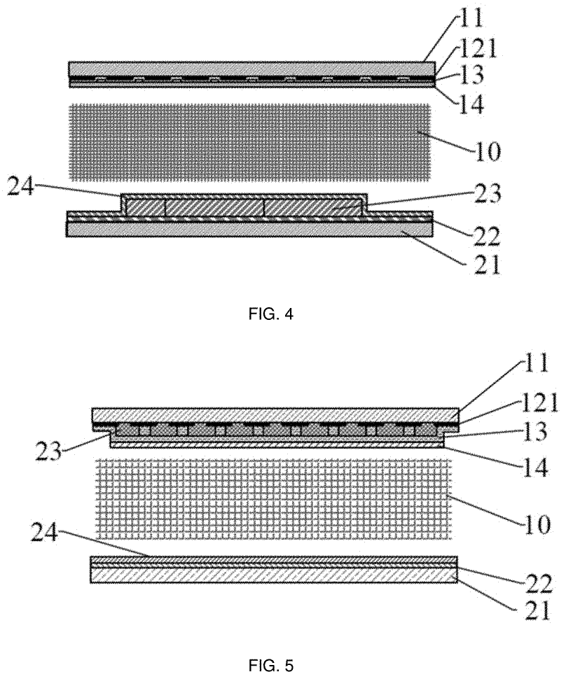

Please refer to FIG. 3 and FIG. 4. An embodiment of the present disclosure further provides a substrate for a liquid crystal display panel comprising a base substrate 11, and a black matrix 121, wherein the black matrix 121 is disposed on one surface of the base substrate 11, and the black matrix 121 is a pattern layer of MoTi. A thickness of the black matrix 121 ranges from 1000 Å-2000 Å (0.1-0.2 μm), which further flattens the topography of the surface of the substrate. When alignment liquid 141 is sprayed on the surface of the substrate, the alignment liquid 141 can easily cross the height of 1000 Å-2000 Å, and then flow into other pixels without affecting the fluidity of the alignment liquid 141. Then a first alignment film 14 with a uniform thickness is formed on the surface of the substrate.

In some embodiments, a protective layer and a metal electrode layer can be disposed between the black matrix 121 and the first alignment film 14. For example, a protective layer 13 is disposed on the surface of the black matrix 121, and then an ITO conductive film (not shown in the figure) is disposed on the surface of the protective layer 13. The first alignment film 14 is disposed on the surface of the ITO conductive film.

As shown in FIG. 4, an embodiment of the present disclosure also provides a liquid crystal display panel based on COA technology. The liquid crystal display panel comprises the substrate provided by the present disclosure. Specifically, the liquid crystal panel comprises a first substrate 11 and a second substrate 21 that are oppositely arranged in parallel. A black matrix 121 is disposed on a surface of the first substrate 11 facing the second substrate 21, and the black matrix 121 is a pattern layer of MoTi. A thickness of pattern layer of MoTi ranges from 1000 Å-2000 Å(0.1-0.2 μm).

A protective layer 13 and a first alignment film 14 are sequentially disposed on the surface of the black matrix 121. An ITO conductive film may also be disposed between the protective layer 13 and the first alignment film 14.

A TFT array 22, color photoresists 23, and a second alignment film 24 are disposed on the surface of the second substrate 21 facing the first substrate 11, and a liquid crystal layer 10 is disposed between the first alignment film 14 and the second alignment film 24.

The black matrix provided by the present disclosure is not limited to the COA type liquid crystal display panel. Please refer to FIG. 5. The liquid crystal panel comprises a first substrate 11 and a second substrate 21 that are oppositely arranged in parallel. A black matrix 121 is disposed on a surface of the first substrate 11 facing the second substrate 21, and the black matrix 121 is a pattern layer of MoTi. A thickness of the pattern layer of MoTi ranges from 1000 Å-2000 Å. Color photoresists 23 are disposed on the surface of the first substrate 11 facing the second base substrate 21, and the color photoresists 23 are disposed on an upper surface of the black matrix 121.

A protective layer 13 and a first alignment film 14 are sequentially disposed on the surface of the black matrix 121. An ITO conductive film may also be disposed between the protective layer 13 and the first alignment film 14.

A TFT array 22 and a second alignment film 24 are disposed on the surface of the second substrate 21 facing the first substrate 11, and a liquid crystal layer 10 is disposed between the first alignment film 14 and the second alignment film 24.

While the black matrix, the substrate for liquid crystal panel and the liquid crystal panel provided by the present disclosure have been described with the aforementioned embodiments. It is preferable that the above embodiments should not be construed as limiting of the present disclosure. Specific examples are used to illustrate the principles and implementation of the present disclosure. The descriptions of the above examples are only used to help understand the technical solutions and core ideas of the present disclosure; and people of ordinary skill in the art should understand that the technical solutions recorded in the foregoing embodiments can be modified, and some of the technical features thereof can be equivalently replaced. These modifications and replacements do not cause the essence of the corresponding technical solutions to deviate from the scope of the technical solutions of the embodiments of the present application.

1. (canceled)

2. (canceled)

3. A substrate for a liquid crystal panel, comprising a base substrate and a black matrix disposed on a surface of the base substrate, and the black matrix is a pattern layer of MoTi, and a thickness of the pattern layer of MoTi ranges from 1000 Å to 2000 Å.

4. The substrate for a liquid crystal panel as claimed in claim 3, wherein an alignment film is disposed on the surface of the base substrate where the black matrix is disposed.

5. A liquid crystal panel, comprising a first substrate and a second substrate that are arranged oppositely and in parallel, wherein a black matrix, a metal electrode layer, and a first alignment film are arranged sequentially on a surface of the first substrate facing the second substrate, and the black matrix is a pattern layer of MoTi.

6. The liquid crystal panel as claimed in claim 5, wherein the thickness of the pattern layer of MoTi ranges from 1000 Å to 2000 Å.

7. The liquid crystal panel as claimed in claim 5, wherein an OD value of the pattern layer is greater than or equal to 4.

8. The liquid crystal panel as claimed in claim 5, wherein a protective layer is disposed between the black matrix and the first alignment film.

9. The liquid crystal panel as claimed in claim 5, wherein the liquid crystal panel is a COA type liquid crystal panel, and a thin film transistor array and a color photoresist layer are disposed on one side of the second substrate.

10. The liquid crystal panel as claimed in claim 8, wherein a color photoresist layer, an electrode layer and a second alignment film are arranged sequentially on a surface of the second substrate facing the first substrate, and a liquid crystal layer is disposed between the second alignment film and the first alignment film.

11. A manufacturing method for a black matrix for a liquid crystal panel, comprising steps of:
providing a base substrate;
forming a MoTi coating on a surface of the base substrate; and
etching the MoTi coating to form a black matrix pattern.

12. The manufacturing method as claimed in claim 11, wherein a thickness of MoTi in the black matrix pattern ranges from 1000 Å to 2000 Å.

13. The manufacturing method as claimed in claim 11, wherein an OD value of the pattern layer is greater than or equal to 4.

14. The manufacturing method as claimed in claim 11, wherein the MoTi coating is formed by at least one process of sputtering, vapor deposition, and spraying.

15. The manufacturing method as claimed in claim 11, wherein the etching process is photolithography process.

16. The substrate for a liquid crystal panel as claimed in claim 3, wherein an OD value of the pattern layer of MoTi is greater than or equal to 4.
